(19) United States
(12) Patent Application Publication
(10) Pub. No.: US 2010/0209568 A1
(43) Pub. Date: Aug. 19, 2010

(54) Ultrasonic Treatment for Preparing Meat Products

(76) Inventors: Ted Brown, Haven, KS (US); Matthew Gardner, Wichita, KS (US); Matthew S. Osborn, Eureka, KS (US); Alexander Patist, Shakopee, MN (US); Daniel L. Schaefer, Wichita, KS (US); Rudy Steiner, Wichita, KS (US); Mike L. Wiens, Wichita, KS (US)

Correspondence Address: CARGILL, INCORPORATED, P.O. Box 5624, MINNEAPOLIS, MN, 55440-5624, US

(21) Appl. No.: 11/991,992

(22) PCT Filed: Oct. 16, 2006
(86) PCT No.: PCT/US06/40233

§ 371 Date: May 6, 2010

Related U.S. Application Data
(60) Provisional application No. 60/727,591, filed on Oct. 16, 2005.

(51) Int. Cl. A23B 4/015; A23L 3/30; A23B 4/005

(52) U.S. Cl. 426/238

(57) ABSTRACT

The present invention includes a method for preparing a meat product that includes subjecting meat material to ultrasonic energy to reduce the microbial content of the meat material. One embodiment of the method includes subjecting the meat material to ultrasonic energy further comprises subjecting the meat material to about 1×10⁻⁴ to about 1 kilowatt-hour ultrasonic energy per liter meat material. In other embodiments the application of the ultrasonic energy can be varied in terms of energy, duration time, frequency, and temperature to achieve the desired results.

### FIELD OF THE INVENTION

The present invention relates generally to the field of animal products. In particular, the present invention relates to subjecting meat products to ultrasonic energy during processing to reduce microbe content.

### BACKGROUND OF THE INVENTION

Foodstuffs are inevitably exposed to microbes in the course of processing or in the course of handling prior to processing. Microbes are part of the natural decay process of organic material and may be deposited on foodstuffs through the air or by contact between the foodstuff and contaminated equipment or other material.

Although some microbes may be relatively benign, others contribute to spoilage and some can cause serious illness. Lactic acid producing bacteria are examples of benign microbes, while some strains of E. Coli, Salmonella, Listeria, and Staph bacteria are examples of pathogenic microbes which can cause serious illness when ingested by humans.

During excavation, boning and grinding, food pathogens and food spoilage bacteria which are abundantly present in the intestines may get in contact with the fresh meat. As fresh meat is a rich medium with a lot of proteins and fats and has a nearly neutral pH, it is a good location for growth of the food pathogens and food spoilage bacteria.

Microbe content and growth in foodstuffs during processing may be reduced by applying chemical additives or preservatives to the foodstuff. These chemical additives or preservatives, however, may not be acceptable to consumers, or may adversely affect the quality of the foodstuffs. Treatment methods may include treatment with a chlorine solution, with a solution of tri-sodium phosphate, or with a quaternary ammonium compound (“QAC”). Chlorine solutions, however, have been found ineffective in eliminating all of the pathogenic microorganisms. In addition, the concentration of chloride ion can decrease rapidly due to the ion interacting with, for example, nascent oxygen. Tri-sodium phosphate has been used during the reprocessing stage where the inside and outside of poultry is sanitized. This process, however, requires filtering the reprocessor's water before disposal in order to remove tri-sodium phosphate. Furthermore it has been found that QAC's may be effective in removing Salmonella but not necessarily other types of microorganisms. Still other common antimicrobial compositions, while effective on some surfaces, can not be used on food surfaces due to their toxicity.

Accordingly, there is a need for methods for treating food and meat products to eliminate a broad range of microorganisms.

### BRIEF SUMMARY OF THE INVENTION

One embodiment of the present invention includes a process for preparing a meat product including subjecting a meat material to ultrasonic energy to reduce the microbial content.

Another embodiment of the present invention includes a method of preparing a meat product that includes subjecting liquid meat material to ultrasonic energy to reduce the microbial content of the meat product.

An additional embodiment may include a method of processing a meat material including the steps of obtaining a meat material, heating the meat material to produce a heated slurry, separating the heated slurry into a solids stream and a liquids stream, and subjecting at least one of the solids stream and the liquids stream to ultrasonic energy in the range of about 1×10⁻⁴ to about 1 kilowatt-hour ultrasonic energy per liter meat material to reduce the microbial content.

An additional embodiment of the present invention may include a method of producing a meat product with a reduced microbial content that includes obtaining a raw meat product, and subjecting the raw meat product to ultrasonic energy to reduce the microbial content of the raw meat product.

Another embodiment of the present invention may include a method of producing a meat product with a reduced microbial content that includes obtaining animal trimmings of a desired composition, heating the animal trimmings to a desired temperature to form a heated slurry, and subjecting the heated slurry to ultrasonic energy to reduce the microbial content of the meat product.

While multiple embodiments are disclosed, still other embodiments of the present invention will become apparent to those skilled in the art from the following detailed description, which shows and describes illustrative embodiments of the invention. Accordingly, the detailed description is to be regarded as illustrative in nature and not restrictive.

### DETAILED DESCRIPTION

Disclosed are methods for preparing meat products. The method typically includes subjecting meat material, which may include liquid meat material, to ultrasonic energy to produce the meat product.

“Meat material” is material obtained from “meat producing animals,” which are animals that conventionally provide meat for consumption by humans or otherwise. The term “meat material” may include a “meat slurry.” “Meat material” may also include “solid meat material” and “liquid meat material.” “Meat material” may also include “fat reduced beef.”

In some embodiments, the methods disclosed herein may be used to prepare “food grade” meat products. “Food grade” means that up to a specified amount of the specified agent can be ingested by a human without generally causing deleterious health effects. Examples of food grade agents include those additives “generally recognized as safe” (“GRAS”) by the United States Food and Drug Administration (“FDA”) and colorants approved by the FDA for use in foods for human consumption. In particular, food grade additives include those compounds (or mixtures of compounds) listed as approved under 21 C.F.R. §§73, 74, 172, 182 and 184 as well as other compounds recognized by comparable regulatory authorities in other countries. As used herein, “meat product” describes a protein-containing product. In some embodiments, the “meat product” may be suitable for human consumption as meat because it may contain a suitable amount of protein. In other embodiments the meat product may not be suitable for human consumption.

Any suitable meat material may be used in the method. Such meat materials may include animal trimmings, liquefied animal trimmings, a slurry of animal trimmings, a meat slurry, solid meat material, liquid meat material, or mixtures thereof. Generally, “animal trimmings” refers to the tissue cut away from conventional cuts or parts of the carcasses of meat producing animals during butchering operations in packing houses and the like. Conventional cuts or parts are generally sold directly to consumers or are, for example, ground into ground beef. The tissue remaining after the conventional cuts are removed, generally has a fat content which is too high for human consumption as meat, but contains protein which can be recovered. As such, after the animal trimmings are removed from the carcass they may be subjected to a rendering process, for example as disclosed in U.S. Pat. No. 6,949,265. Alternatively, the animal trimmings can be cooled and stored prior to processing. As used herein, “meat material” may include “animal trimmings” that have been subjected to “desinewing” in which one or more of heavy connective tissue, ligaments, tendons, and the like are removed.

Suitable starting material for use in the present methods includes boneless beef or pork trimmings. It should be understood, however, that the present methods could be applied to animal trimmings containing undesirable components such as bone, cartilage, etc. In particular, it may be helpful to remove the undesirable components at some stage during the process. “Animal trimmings” can include relatively small portions of tissue obtained as a result of the slaughter and fabrication operation. Furthermore, “animal trimmings” can include any part of an animal which is trimmed away from the carcass of the animal or the cuts. The animal trimmings can include all the parts normally found in an animal, including adipose tissue, fat, lean, ligaments, tendons, bone parts, and the like. Animal trimmings may also be obtained from any type of animal species.

Lean meat material may be referred to as protein-containing material, and can be in the form of water soluble protein which tends to give the meat its color, salt soluble protein which includes muscle fiber, and non-soluble protein which is generally the connective tissue that surrounds muscle fiber and that attaches the muscle fibers to ligaments.

The meat material used in the present methods may also include liquid meat material that is essentially free of solid meat material. “Liquid meat material” may be referred to as “serum,” which has been obtained by isolating a liquids stream from a slurry of animal trimmings which may include meat.

It is generally desirable that if components other than fat, lean, and moisture are present, they are present in small quantities and/or can be removed in the desinewing step or by hand, if desired, or can be left therein if their presence does not adversely affect the properties of the meat product. If large amounts of certain components are present, it may be desirable to have them removed by conventional separation techniques prior to processing according to the present methods. For example, it is generally desirable not to have large amounts of bone present or large amounts of low quality ligaments. In general, these small portions may include trimmings from animal carcasses. Typically, the small portions of animal trimmings will have a size ranging from about 0.5 inch to about 16 inches in length, referring to the longest dimension. In general, the animal trimmings of the present methods generally have an average weight of between about 0.25 lbs and about 12 lbs. per tissue piece.

Animal trimmings suitable for the methods disclosed herein may have an average fat content up to about 80% (wt./wt.) (All percentages given as weight/weight unless otherwise noted) or more by weight, and more preferably about 40% by weight. In order to ensure reliable and consistent results, it may be preferable that the lean content of the animal trimmings be at least 37% by weight, and even more preferably at least 39% by weight. It should be kept in mind that the lean content includes protein and moisture. In some embodiments, the meat material has a fat content of no more than about 50%, preferably no more than about 40%.

In further embodiments, the method may be used to produce a meat product with a fat content of no more than about 30%, preferably no more than 20%, even more preferably no more than about 10%. In other embodiments, the method may be used to produce a meat product with a protein content of at least about 10%, preferably at least about 15%, more preferably at least about 20%. In other embodiments the protein content may be as high as 90% or more.

The meat material may include material from any other suitable source. For example, the meat material may be selected from beef, pork, poultry, lamb, deer, horse, rabbit, fish, wild game, and combinations thereof. The meat material may include animal trimmings. “Meat producing animals” may include any of the animals referenced above.

The method may typically include subjecting the meat material to about 1×10⁻⁴ to about 1 kilowatt-hour or more ultrasonic energy per volume meat material (i.e., joules per liter meat material). In some embodiments, the method includes subjecting the meat material to about 1×10⁻⁴ to about 1×10⁻² kilowatt-hour ultrasonic energy per volume meat material, or about 1×10⁻⁴ to about 1×10⁻³ kilowatt-hour ultrasonic energy per volume meat material.

As used herein, “ultrasonic energy” means mechanical, vibratory energy that operates at frequencies greater than audible sound. “Ultrasonic energy” has a frequency that is inaudible to the human ear, typically at least about 10 kHz, and more typically at least about 16 kHz or at least about 20 kHz. Systems for generating ultrasonic energy are available from commercial sources (e.g., Hielscher GmbH, Teltow, DE). The ultrasonic energy generated by these systems typically has a frequency of about 15-100 kHz. In some embodiments, the ultrasonic energy has a frequency of about 20-50 kHz. In some embodiments, the ultrasonic energy has a frequency of about 16-50 kHz or more preferably about 16-24 kHz. In some embodiments, the meat material is subjected to ultrasonic energy having a power of about 0.2-25 kW. In other embodiments, the meat material is subjected to ultrasonic energy having a power of about 0.3-20 kW. In further embodiments, the meat material is subject to ultrasonic energy having a power of about 0.4-15 kW.

Ultrasonic processors are known in the art and permit variation with respect to the ultrasonic energy that they produce. Systems may be devised that include transducers that provide discrete power units (e.g., 1 kW, 2 kW, 4 kW, 8 kW, 16 kW, or combinations and/or multiples thereof). Generally, these systems utilize one of two types of probes for administering ultrasonic energy (i.e., “sonotrodes”). These include axial probes and radial probes, either of which are suitable for the method described herein.

Commercial ultrasonic systems typically allow the user to vary the power of the ultrasonic energy and the “hold time” for the sample, (i.e., the amount of time that the sample is exposed to the ultrasonic energy). The power and/or hold time may be inversely varied to administer a desirable amount of energy to a volume of the meat material. For example, the meat material may be subjected to ultrasonic energy having power P₁ for a hold time H₁. Alternatively, the meat material may be subject to ultrasonic energy having power P₂ for a hold time H₂, where P₁(H₁)=P₂(H₂). In some embodiments, the ultrasonic energy may have a power that varies from about 0.2-20 kW, or in other embodiments from about 0.4-2.0 kW.

The meat material may be subjected to ultrasonic energy for any suitable period of time. The meat material may be subjected to ultrasonic energy for about 5-120 seconds or in other cases for about 10-90 or about 15-60 seconds. As may be appreciated, power, frequency, energy, and hold time may be varied to obtain a suitable product. For example, the meat material may be subjected to ultrasonic energy for about 1-60 seconds or less than 1 second. In some embodiments, the meat material is subjected to ultrasonic energy for at least about 30 seconds. In other embodiments, the meat material is subject to ultrasonic energy for at least about 60 seconds (1 minute). In further embodiments, the meat material is subjected to ultrasonic energy for at least about 90 seconds (1.5 minutes). In even further embodiments, the meat material is subjected to ultrasonic energy for at least about 120 seconds (2 minutes).

The number of viable microbes that may be present in the meat product after being subjected to ultrasonic energy may be determined by plating a sample of the meat product on a suitable bacteria media. Media for selective growth of bacteria is known in the art. For example, media for selective growth of aerobic bacteria, Enterobacteriaceae, and E. coli/coliforms are available from commercial sources. Other methods for detecting bacteria are known in the art. The number of viable microbes that may be present in the meat product may then be determined absolutely or relative to a sample that has not been subjected to ultrasonic energy.

In one embodiment where the numbered viable microbes is determined absolutely, the meat material may be subjected to ultrasonic energy for a sufficient period of time to produce a meat product having a total aerobic plate count per milliliter, for example, of no more than about 400 CFU/ml, preferably no more than about 200 CFU/ml, even more preferably no more than about 100 CFU/ml.

In another embodiment, the meat material may be subjected to ultrasonic energy for a sufficient period of time to produce a meat product having a total Enterobacteriaceae count per milliliter of no more than about 400 CFU/ml, preferably no more than about 200 CFU/ml, even more preferably no more than about 100 CFU/ml.

In a further embodiment, the meat material may be subjected to ultrasonic energy for a sufficient period of time to produce a meat product having a total Salmonella count per milliliter of no more than about 100 CFU/ml, preferably no more than about 50 CFU/ml, even more preferably no more than about 10 CFU/ml.

In another embodiment, the meat material may be subjected to ultrasonic energy for a sufficient period of time to produce a meat product having a total Enterobacteriaceae count per milliliter of no more than about 1000 CFU/ml, preferably no more than about 500 CFU/ml, even more preferably no more than about 100 CFU/ml.

In other embodiments, the meat material may be subjected to ultrasonic energy for a sufficient period of time to produce a meat product having a total E. coli count per milliliter of no more than about 50 CFU/ml, preferably no more than about 20 CFU/ml, even more preferably no more than about 10 CFU/ml. In further embodiments, the meat material may be subjected to ultrasonic energy for a sufficient period of time to produce a meat product having a total coliform count per milliliter of no more than about 50 CFU/ml, preferably no more than about 20 CFU/ml, even more preferably no more than about 10 CFU/ml. In even further embodiments, the meat material may be subjected to ultrasonic energy for a sufficient period of time to produce a liquid meat product having a total Salmonella count per milliliter of no more than about 1000 CFU/ml, preferably no more than about 700 CFU/ml, even more preferably no more than about 100 CFU/ml.

In other embodiments, when the number of viable microbes in the meat material may be calculated as relative to a meat material that has not been subjected to ultrasonic energy, for example, the meat material may be subjected to ultrasonic energy for a sufficient period of time to produce a meat product having a total aerobic plate count per milliliter of no more than about 25% relative to meat material that has not been subjected to ultrasonic energy. In other embodiments the total aerobic plate count may be no more than about 20% relative to meat material that has not been subjected to ultrasonic energy, even more preferably no more than about 15% relative to meat material that has not been subjected to ultrasonic energy. In another example, the meat material may be subjected to ultrasonic energy for a sufficient period of time to produce a meat product having a total aerobic plate count per milliliter of no more than about 10% relative to meat material that has not been subjected to ultrasonic energy, preferably no more than about 5% relative to meat material that has not been subjected to ultrasonic energy, even more preferably no more than about 1% relative to meat that has not been subjected to ultrasonic energy, and even more preferably no more than about 0% relative to meat material that has not been subjected to ultrasonic energy. In even further embodiments, the meat material may be subjected to ultrasonic energy for a sufficient period of time to produce a meat product having a total Salmonella or Enterobacteriaceae count per milliliter of no more than about 10% relative to meat material that has not been subjected to ultrasonic energy, preferably no more than about 5% relative to meat material that has not been subjected to ultrasonic energy, even more preferably no more than about 2% relative to meat material that has not been subjected to ultrasonic energy, even more preferably no more than about 0.5% relative to meat material that has not been subjected to ultrasonic energy, and even more preferably no more than about 0% relative to meat material that has not been subjected to ultrasonic energy.

In other embodiments, the meat material may be subjected to ultrasonic energy for a sufficient period of time to produce a meat product having a total E. coli count per milliliter of no more than about 15% relative to meat material that has not been subjected to ultrasonic energy, preferably no more than about 10% relative to meat material that has not been subjected to ultrasonic energy, even more preferably no more than about 5% relative to meat material that has not been subjected to ultrasonic energy, and even more preferably no more than about 0% relative to meat material that has not been subjected to ultrasonic energy.

In further embodiments, the meat material may be subjected to ultrasonic energy for a sufficient period of time to produce a meat product having a total coliform count per milliliter of no more than about 10% relative to meat material that has not been subjected to ultrasonic energy, preferably no more than about 5% relative to meat material that has not been subjected to ultrasonic energy, even more preferably no more than about 2% relative to meat material that has not been subjected to ultrasonic energy, even more preferably no more than about 0% relative to meat material that has not been subjected to ultrasonic energy.

In one embodiment, the meat material may be heated to a suitable temperature for a suitable period of time effective to liquefy fat and/or effective to reduce the pathogen load (e.g., by heat killing bacteria that may be present in the meat material). In a further embodiment, the meat material includes a slurry of animal trimmings that may be heated to a temperature of about 30-60° C. The method may include further steps such as separating the heated slurry into a solids stream and a liquids stream that includes liquid meat material, either before or after being subjected to ultrasonic energy. The meat material may include liquid meat material that is essentially free of solid material.

In one embodiment, the slurry may be prepared by processing animal trimmings in a transfer fluid. The slurry may include animal trimmings in an aqueous solution. In one embodiment, the slurry may be prepared by heating animal trimmings in a bath. The animal trimmings may have been previously surface treated by heating the animal trimmings for about 25-150 seconds in a bath with a heat transfer fluid provided at a temperature of about 80-120° C. In some embodiments, the animal trimmings may be prepared by removing one or more of connective tissues, ligaments, and tendons to produce animal trimmings prior to preparation of the slurry.

In some embodiments, the methods disclosed herein may be used to prepare a meat product from a slurry of animal trimmings. A slurry may be prepared by any suitable method including the method disclosed in U.S. Pat. No. 6,949,265. A slurry may include “fat reduced beef.” The methods disclosed herein may include further steps such as separating the slurry into a solids stream and a liquids stream that includes liquid meat material (e.g., as disclosed in U.S. Pat. No. 6,949,265).

In some embodiments, the meat material is treated to obtain liquid meat material that is essentially free of fat. The methods for preparing a liquid meat product may be performed continuously or discontinuously. The methods for preparing a liquid meat product may be combined with other methods to prepare meat products. For example, the methods for preparing a meat product may be combined with the methods for preparing a liquid meat product.

Further, methods of preparing meat products are disclosed in U.S. Pat. No. 6,949,265; U.S. Pat. No. 6,159,515; U.S. Pat. No. 5,965,184; and U.S. Pat. No. 5,725,897, the contents of which are incorporated herein by reference for all that they teach and disclose. The methods disclosed herein may be combined with the methods disclosed in these patents to produce meat products. In particular, the methods disclosed herein may be used instead of the steps disclosed in these patents that are related to pasteurization of the meat products.

In some embodiments of the method, the meat material is not heated to a temperature of more than about 60° C., preferably no more than about 55° C., even more preferably no more than about 50° C.

In other embodiments, the method includes heating the meat material to a temperature of about 80-150° C. for any suitable period of time. In some embodiments, the meat material is heated to a temperature of about 80-150° C. for about 25-150 seconds. The meat material may also be heated under pressure, e.g., to a temperature of about 80-150° C. under pressure of at least about 300 mPa. Other pressures may be achieved as desired.

In other embodiments, the ultrasonic treatment method may be combined with a method for using carbon monoxide (CO) as a process aid to ameliorate the loss of the red color in fatty meat trimmings during rendering. Such a CO treatment method may be utilized in processing fatty beef trimmings into finely textured beef (FTB). The FTB is produced by a low temperature rendering process of fatty beef trimmings. One target FTB may be, for example, 95% chemical lean with +/−1% upper and lower control limits.

Beef with a brown color is associated with cooked or old meat and is undesirable to the consumer. Because of the detrimental impact on color resulting from current processes for producing FTB from meat and meat by-products, only about 10-15% by weight of FTB can be incorporated into most fresh ground beef and still produce a product that is pleasing to the consumer's eye. The use of CO may allow FTB to be produced with a more pleasing color and thus allows for a greater amount of FTB to be added to ground beef and other meat products. The FTB can be added to the ground beef products at levels of up to 25% or more. In other embodiments the FTB may be incorporated into products up to about 30, 35, 40, 45%, or 50% or more.

Combining the ultrasonic method with the CO method may help to produce FTB that has both a reduced microbe content and a more pleasing color to the consumer. Methods of preparing meat products utilizing CO are disclosed in U.S. Application Nos. 60/695,904, field on Jul. 1, 2005, Ser. No. 11/253,194, filed on Oct. 18, 2005, 60/755,651, filed on Dec. 30, 2005, and PCT/US2006/25879, filed on Jun. 30, 2006, the contents of which are incorporated herein by reference for all that they teach and disclose.

In one embodiment, the method may be practiced by performing the following steps: (a) subjecting animal trimmings (which may be present in a transfer fluid) to ultrasonic energy as disclosed herein to provide treated animal trimmings; (b) heating the treated animal trimmings (e.g., in a heat exchanger having a first-in and first-out arrangement) to a suitable temperature (e.g., a temperature in the range of about 30-50° C.) to form a heated slurry; and (c) separating the heated slurry into a solids stream and a liquids stream (e.g., by feeding the heated slurry to a decanter or centrifuge or centrifuge). Optionally, the liquids stream may be further separated into a heavy phase and a light phase, either of which phase may be combined with the solids stream to prepare a meat product.

In some embodiments, the method may be practiced by performing the following steps: (a) heating animal trimmings to a suitable temperature (e.g., about 30-50° C.) to form a heated slurry; (b) separating the heated slurry into a solids stream and a liquids stream, (and optionally, further separating the liquids stream into a heavy phase and a light phase); and (c) subjecting at least one of the animal trimmings, the heated animal trimmings, the heated slurry, the solids stream, the liquids stream, the heavy phase of the liquid stream, and the light phase of the liquid stream to ultrasonic energy as disclosed herein. Optionally, the heavy phase of the liquid stream, the light phase of the liquid stream, or both may be combined with the solids stream to prepare a meat product.

In some embodiments, the method may be practiced by performing the following steps: (a) heating animal trimmings in a heat exchanger (e.g., a heat exchanger having a first-in and first-out arrangement) to a suitable temperature (e.g., a temperature in the range of about 30-50° C.) to form a heated slurry; (b) subjecting the heated slurry to ultrasonic energy as disclosed herein; and (c) separating the heated slurry into a solids stream and a liquids stream (e.g., by feeding the heated slurry to a decanter or centrifuge). Optionally, the liquids stream may be further separated into a heavy phase and a light phase (e.g., by feeding the liquids stream to a separator), either of which phase optionally may be combined with the solids stream to prepare a meat product.

In other embodiments, the method may be practiced by performing the following steps: (a) heating animal trimmings (e.g., in a heat exchanger having a first-in and first-out arrangement) to a suitable temperature (e.g., a temperature in the range of about 30-50° C.) to form a heated slurry; (b) separating the heated slurry into a solids stream and a liquids stream (e.g., by feeding the heated slurry to a decanter or centrifuge); and (c) subjecting at least one of the solids stream and the liquids stream to ultrasonic energy as disclosed herein. Optionally, the liquids stream may be further separated into a heavy phase and a light phase (e.g., by feeding the liquids stream to a separator), either of which phase optionally may be combined with the solids stream to prepare a meat product.

In further embodiments, the method may be practiced by performing the following steps: (a) heating animal trimmings (e.g., in a heat exchanger having a first-in and first-out arrangement) to a suitable temperature (e.g., a temperature in the range of about 30-50° C.) to form a heated slurry; (b) separating the heated slurry into a solids stream and a liquids stream (e.g., by feeding the heated slurry to a decanter or centrifuge); (c) further separating the liquids stream into a heavy phase and a light phase (e.g., by feeding the liquids stream to a separator), and (d) subjecting at least one of the animal trimmings, the heated animal trimmings, the heated slurry, the solids stream, the liquids stream, the heavy phase of the liquids stream, and the light phase of the liquids stream to ultrasonic energy as disclosed herein. Optionally, the heavy phase of the liquids stream, the light phase of the liquids stream, or both may be combined with the solids stream to prepare a meat product.

In even further embodiments, the method may be practiced by performing the following steps: (a) surface treating animal trimmings with a heat transfer fluid (e.g., a heat transfer fluid provided at a temperature of about 80-150° C.) for a suitable time period (e.g., a time period of about 25-150 seconds) to provide surface treated animal trimmings; (b) heating the surface treated animal trimmings in a heat exchanger (e.g., a heat exchanger having a first-in and first-out arrangement) to a suitable temperature (e.g., a temperature in the range of about 30-50° C.) to form a heated slurry; (c) separating the heated slurry into a solids stream and a liquids stream (e.g., by feeding the heated slurry to a decanter or centrifuge); and (d) subjecting at least one of the animal trimmings, the surface treated animal trimmings, the heated slurry, the solids stream, and the liquids stream to ultrasonic energy as disclosed herein. Optionally, the liquids stream may be further separated into a heavy phase and a light phase (e.g., by feeding the liquid stream to a separator), and the heavy phase, the light phase, or both may be subjected to ultrasonic energy. Optionally, the heavy phase, the light phase, or both may be combined with the solids stream to prepare a meat product.

The methods may be used to prepare a liquid meat product by subjecting liquid meat material to ultrasonic energy to prepare a liquid meat product. The liquid meat material may be prepared by isolating a liquid fraction (e.g., a liquids stream) from a slurry of animal trimmings as disclosed herein to obtain liquid meat material. For example, the liquid meat material may be obtained from a slurry of animal trimmings by separating the slurry into a solids stream and liquid stream (e.g., by using a decanter or centrifuge). The liquid stream may be further separated into a heavy phase and a light phase (e.g., by feeding the liquid stream to a separator). Liquid meat material may include the liquid stream, the heavy phase of the liquid stream, the light phase of the liquid stream, or mixtures thereof.

Some of the meat material and meat products disclosed herein may be recited as “essentially free” of one or more recited components (e.g., “essentially free of solid meat material” or “essentially free of fat”). As used herein “essentially free” means having no more than 5% of a recited component by weight relative to the total weight of the product (i.e., wt./wt.), preferably no more than about 2% of the recited component by weight relative to the total weight of the product, even more preferably no more than 1% of the recited component by weight relative to the total weight of the product.

Additional steps may include, but are not limited to, desinewing, chopping, decanting, and separating. Desinewers are available commercially (290/125-7PX Pump Deboner, Simo Industries); as are rotary choppers (Commitrol, Urschel Laboratories Co.); decanters (CA 405 Decanter, Westfalia Separator AG); and separators (RSD 300-96-777 Clarifier, Westfalia Separator AG).

### Example I

Inoculum: Salmonella typherium culture (ATCC #14028) was grown in tryptic soy broth for 18-24 hours at 35° C. The culture was reserved for inoculation.

Slurry product: A slurry was prepared by subjected a beef sample to a rotary chopper (Commitrol, Urschel Laboratories Co.) to produce a slurry product. Samples of the slurry product were collected and subsequently frozen using dry ice until date of analysis. The samples were thawed and brought up to a temperature of about 40-41° C. (˜104-105° F.). Portions of the samples were plated on suitable media to determine Enterobacteriaceae counts, E. coli counts, coliform counts, Gram negative bacteria counts, and aerobic plate counts.

Serum product: Liquid meat material (i.e., “serum product”) was obtained from a slurry product using a separator. Serum product samples were collected and subsequently frozen using dry ice. Serum product samples were held at frozen temperature until 5 days before date of analysis. Serum product samples were thawed and brought to a temperature of about 40-41° C. (˜104-105° F.). Portions of the samples were plated on suitable media to determine Enterobacteriaceae counts, E. coli counts, coliform counts, Gram negative bacteria counts, and aerobic plate counts.

Inoculation of samples: Slurry product samples and serum product samples were weighed into 100 gram portions to obtain a total of six (6) samples per product type. Target inoculum (10⁵ CFU) was achieved by preparing serial dilution of the 18-24 hour pure culture in 0.1% Peptone. Diluted inoculum (0.1 mL, 10⁵ CFU) was added to each 100 g sample. Serial dilutions of the inoculated sample were plated on Enterobacteriaceae Petri-film to determine actual inoculum level.

Controls: One sample per treatment of non-inoculated control was designated per product type. Three untreated, inoculated controls were designated for each product type.

Treatment: Samples were treated using a UP400S (400 Watts, 24 kHz) ultrasonic processor (Hielscher GmbH). The axial (focuses) probe was used to treat 50 ml of solution in a beaker for one (1) minute or two (2) minutes. Because treatment with sonic energy heated the samples, all samples were maintained at a temperature of about 40-41° C. (˜104-105° F.) by immersing the sample beaker in ice water.

Bacterial counts: All samples were plated using ATP 4013.01 for Enterobacteriaceae, ATP 4002.01 for E. coli/coliforms; and APC 4001.02 for aerobic plate counts. Plates were incubated and enumerated according to standard protocols. Results are displayed in TABLE 1.

TABLE 1

| | | Colony Forming Units Per Milliliter (CFU/ml) | | | | |
|---|---|---|---|---|---|---|
| Sample | Treatment | APC | EB | E. coli | Coliforms | GNB* |
| SLURRY PRODUCT | Treated | 290 | <100 | <10 | <10 | <10 |
| | (1 minute) | | | | | |
| | Non-Treated | 1510 | 5000 | <10 | <10 | 1310 |
| | Treated | 80 | <100 | <10 | <10 | <10 |
| | (2 minute) | | | | | |
| | Non-Treated | 4,600 | 6,000 | <100 | <100 | 3,900 |
| SERUM PRODUCT | Treated | 5,250,000 | 1,700 | 110 | 110 | 960 |
| | (1 minute) | | | | | |
| | Non-Treated | 1,650,000 | 10,000 | 50 | 400 | 400 |
| | Treated | 6,250,000 | 500 | 20 | 20 | 660 |
| | (2 minute) | | | | | |
| | Non-Treated | 4,450,000 | 22,000 | 400 | 1,100 | 10,500 |

*GNB—Gram negative bacteria.

The results as summarized in Table 1 showed statistically significant improvements, for the serum product, in terms of EB, E. coli, coliforms, and GNB content in the two minute treatment samples and in terms of EB content for the one minute treatment samples. (Data analyzed by taking the log of the raw CFU/ml data). Statistically significant improvements were furthermore found for the slurry product for all of the microbes for the two minute treatment samples. Improvements were also realized for the ABC, EB, and GNB samples after treating the slurry for one minute.

### Example II

In a second test, the ultrasonic energy was applied to a meat slurry during large scale production of a meat product. In the present example the meat slurry consisted of beef trimmings that had been run through a 7/64 inch grinder to obtain a material that was approximately 70% fat. The meat slurry was heated to approximately 105° F. during a rendering process. The meat slurry was heated by pumping it under pressure through a 3 inch water/steam jacketed pipe at a controlled rate. The meat slurry was exposed to the ultrasonic energy from an 8 kW probe while in the pipe. The temperature of the meat slurry may range between about 98.6° F. and about 117.8° F. during the ultrasonic energy application. Samples were obtained before and after the meat slurry was pumped through the pipe and exposed to the ultrasonic energy. After ultrasonic treatment the meat slurry may be utilized in various ways known to those in the art.

TABLE 2

| | | Frequency | Flow | | | Temp | Temp |
|---|---|---|---|---|---|---|---|
| Test | Pellet | Hz | g/m | KW | psi | In (F.) | Out (F.) |
| 1 | 3 | 20513 | 5.8 | 6.4 | 52 | 104.3 | 120.3 |
| 2 | 4 | 20482 | 5.7 | 5.8 | 45 | 107.2 | 122.6 |
| 3 | 1 | 20539 | 5.7 | 6.3 | 48 | 103.1 | 115.0 |
| 4 | 2 | 20485 | 5.5 | 5.8 | 48 | 108.5 | 120.0 |
| 5 | 3 | 20500 | 5.8 | 6.0 | 46 | 104.1 | 115.4 |
| 6 | 4 | 20480 | 5.7 | 5.7 | 54 | 107.4 | 118.8 |
| 7 | 1 | 20465 | 5.3 | 5.7 | 50 | 105.9 | 118.8 |
| 8 | 2 | 20461 | 5.4 | 6.9 | 56 | 104.3 | 113.0 |
| 9 | 3 | 20426 | 5.7 | 6.6 | 62 | 104.2 | 115.9 |
| 10 | 4 | 20422 | 5.7 | 6.0 | 54 | 104.8 | 116.1 |
| 11 | 4 | 20435 | 5.7 | 6.4 | 70 | 110.2 | 121.4 |
| 12 | 1 | 20400 | 3.5 | 6.0 | 53 | 112.6 | 123.7 |

TABLE 3

| | APC | APC | | EB | Coliform | Coliform | E. Coli | E. Coli |
|---|---|---|---|---|---|---|---|---|
| Test | Input | Output | EB Input | Output | Input | Output | Input | Output |
| 1 | 35500 | 460 | 1500 | 40 | 660 | 10 | 460 | 10 |
| 2 | 19800 | 1370 | 1500 | 10 | 590 | 10 | 340 | 10 |
| 3 | 23400 | 3500 | 460 | 80 | 250 | 60 | 160 | 10 |
| 4 | 43200 | 1280 | 1700 | 10 | 750 | 10 | 620 | 10 |
| 5 | 39800 | 460 | 900 | 20 | 790 | 10 | 690 | 20 |
| 6 | 30000 | 990 | 2300 | 20 | 620 | 30 | 540 | 10 |
| 7 | 30300 | 1360 | 440 | 10 | 460 | 20 | 370 | 10 |
| 8 | 4300 | 1100 | 100 | 10 | 60 | 10 | 10 | 10 |
| 9 | 17900 | 1380 | 340 | 30 | 240 | 10 | 180 | 10 |
| 10 | 12200 | 1630 | 270 | 50 | 190 | 10 | 160 | 10 |
| 11 | 200000 | 5500 | 3700 | 30 | 1500 | 20 | 900 | 10 |
| 12 | 20200 | 1180 | 310 | 10 | 230 | 10 | 170 | 10 |

As can be seen by the results shown above, statistically significant improvements in the amount of APC (aerobic plate count), EB, Coliform, and E, Coli were realized after treatment with the ultrasonic energy.

All references, patents, and/or applications cited in the specification are incorporated by reference in their entireties, including any tables and figures, to the same extent as if each reference had been incorporated by reference in its entirety individually.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

In addition, where features or aspects of the invention are described in terms of Markush groups or other grouping of alternatives, those skilled in the art will recognize that the invention is also thereby described in terms of any individual member, any subgroup of members of the Markush group or other group, or the totality of members of the Markush group or other group.

Also, unless indicated to the contrary, where various numerical values are provided for embodiments, additional embodiments are described by taking any 2 different values as the endpoints of a range. Such ranges are also within the scope of the described invention.

1. A method for preparing a meat product comprising subjecting a meat material to ultrasonic energy to reduce the microbial content.

2. The method of claim 1, wherein subjecting the meat material to ultrasonic energy further comprises subjecting the meat material to about 1×10⁻⁴ to about 1 kilowatt-hour ultrasonic energy per liter meat material.

3. The method of any of claims 1-2, wherein subjecting the meat material to ultrasonic energy further comprises subjecting the meat material to a frequency of about 15 to about 100 kHz, preferably about 16 to about 24 kHz.

4. The method of any of claims 1-2, wherein subjecting the meat material to ultrasonic energy further comprises subjecting the meat material to ultrasonic energy having a power of about 0.2 to about 25 kW.

5. The method of any of claims 1-4, wherein subjecting the meat material to ultrasonic energy further comprises subjecting the meat material to ultrasonic energy for up to about 90 seconds.

6. The method of any of claims 1-5, wherein the meat material is subjected to ultrasonic energy for a sufficient period of time to produce a meat product having a total aerobic plate count per milliliter of no more than about 25% relative to meat material that has not been subjected to ultrasonic energy.

7. The method of any of claims 1-5, wherein subjecting the meat material to ultrasonic energy further comprises subjecting the meat material to ultrasonic energy for a sufficient period of time to produce a meat product having a total Enterobacteriaceae count per milliliter of no more than about 5% relative to meat material that has not been subjected to ultrasonic energy.

8. The method of any of claims 1-5, wherein the meat material is subjected to ultrasonic energy for a sufficient period of time to produce a meat product having a total aerobic plate count per milliliter of no more than about 400 CFU/ml, preferably no more than about 200 CFU/ml, even more preferably no more than about 100 CFU/ml.

9. The method of any of claims 1-8, further comprising heating the meat material to a temperature of about 80-150° C.

10. The method of claims 1-8, wherein the meat material is heated to a temperature of about 80-150° C. for about 25-150 seconds.

11. The method of any of claims 1-8, wherein the meat material has a weight to weight fat content of no more than about 50%.

12. The method of any of claims 1-8, wherein the meat product has a protein content at least about 10%.

13. The method of any of claims 1-12, wherein the meat material comprises meat material selected from the group consisting of beef material, pork material, poultry material, lamb material, deer material, fish material, and combinations thereof.

14. The method of any of claims 1-12, wherein the meat material comprises animal trimmings.

15. The method of any of claims 1-14, wherein the meat material comprises a shiny of animal trimmings.

16. A method of preparing a meat product comprising subjecting liquid meat material to ultrasonic energy to reduce the microbial content of the meat product.

17. A method of processing a meat material comprising:
obtaining a meat material;
heating the meat material to produce a heated slurry;
separating the heated slurry into a solids stream and a liquids stream; and
subjecting at least one of the solids stream and the liquids stream to ultrasonic energy in the range of about 1×10⁻⁴ to about 1 kilowatt-hour ultrasonic energy per liter meat material to reduce the microbial content.

18. A method of producing a meat product with a reduced microbial content comprising:
obtaining a raw meat product; and
subjecting the raw meat product to ultrasonic energy to reduce the microbial content of the raw meat product.

19. A method of producing a meat product with a reduced microbial content comprising:
obtaining animal trimmings of a desired composition;
heating the animal trimmings to a desired temperature to form a heated slurry; and
subjecting the heated slurry to ultrasonic energy to reduce the microbial content of the meat product.

20. The method of claim 19, wherein subjecting the meat material to ultrasonic energy further comprises subjecting the meat material to about 1×10⁻⁴ to about 1 kilowatt-hour ultrasonic energy per liter meat material.

21. The method of any of claims 19-20, wherein subjecting the meat material to ultrasonic energy further comprises subjecting the meat material to a frequency of about 15 to about 100 kHz, preferably about 16 to about 24 kHz.

22. The method of any of claims 19-20, wherein subjecting the meat material to ultrasonic energy further comprises subjecting the meat material to ultrasonic energy having a power of about 0.2 to about 25 kW.
